(19) United States
(12) Patent Application Publication
(10) Pub. No.: US 2012/0328202 A1
(43) Pub. Date: Dec. 27, 2012

(54) METHOD AND APPARATUS FOR ENROLLING A USER IN A TELEPRESENCE SYSTEM USING A FACE-RECOGNITION-BASED IDENTIFICATION SYSTEM

(75) Inventors: Dihong Tian, San Jose, CA (US); J. William Mauchly, Berwyn, PA (US); Joseph T. Friel, Ardmore, PA (US)

(73) Assignee: CISCO TECHNOLOGY, INC., San Jose, CA (US)

(21) Appl. No.: 13/165,405

(22) Filed: Jun. 21, 2011

(51) Int. Cl. G06K 9/62

(52) U.S. Cl. 382/209

(57) ABSTRACT

In one embodiment, a method includes obtaining a first image of a party that is stored in a first structure in response to an instruction to enroll the user in a system, and using information associated with the first image to identify a second image stored in a second structure. The second image has a relatively high likelihood of depicting the party. Finally, the method includes enrolling the party in the system, wherein enrolling the party in the system includes associating the second image with the party.

### BACKGROUND

The disclosure relates generally to telepresence systems and, more specifically, to efficiently allowing users to efficiently enroll in a telepresence system with relatively high-quality biometric signatures and, thus, allowing the users to be identified in telepresence session with relatively high accuracy.

Telepresence systems, e.g., telepresence video-conferencing systems, allow parties at different locations to interact as if the parties were present at the same location. In the course of using a telepresence system, as for example for the purpose of being identified as being present during a telepresence session, a user of the telepresence system may effectively enroll in the telepresence system using a face-recognition-based identification system. Enrolling in a telepresence system using a face-recognition-based identification system may include creating a user profile using a high-quality biometric signature, as a high-quality biometric signature would substantially ensure a high performance level, e.g., relatively high recognition performance. Creating a user profile may include associating a biometric signature with the identification of a user. For example, using a relatively high resolution image of a user to enroll the user in a telepresence system would increase the quality of a biometric signature created using feature sets associated with the user, and thereby increase the likelihood that the user may be recognized by the telepresence system when an image of the user is obtained during a telepresence session and compared against biometric signatures of other users of the telepresence system.

An enrollment process used to enroll a party in a telepresence system may be complicated and, as a result, time-consuming. For example, requiring that a party obtain relatively high resolution, high-quality images of himself or herself, and then upload that image to a telepresence system may be complicated. Although many telepresence systems may access a directory system such as a corporate directory database that contains information relating to a particular party to obtain an image of the party and, thus, reduce the complexity of an enrollment process, images contained in a directory system are often of low quality. In addition, many images contained in a directory system may be outdated, and a party may no longer appear as her or she did when an image was taken for the directory system. There may also be few images of the party stored in the directory system. Although a relatively high resolution image may be obtained and loaded into a directory system such that a telepresence system may access the relatively high resolution image, it is often impractical an inefficient to require that parties obtain new images for the directory system.

### BRIEF DESCRIPTION OF THE DRAWINGS

The disclosure will be readily understood by the following detailed description in conjunction with the accompanying drawings in which:

FIGS. 1A and 1B are a process flow diagram which illustrates a method of enrolling a user in a telepresence system in accordance with an embodiment.

FIG. 2 is a process flow diagram which illustrates a process of extracting a feature set from an image of a user, e.g., step 129 of FIG. 1A, in accordance with an embodiment.

FIG. 3 is a process flow diagram which illustrates a process of retrieving sample images based on a feature set, e.g., step 133 of FIG. 1A, in accordance with an embodiment.

FIG. 4 is a block diagram representation of a telepresence system in accordance with an embodiment.

FIG. 5 is a diagrammatic representation of a method of enrolling a user in a telepresence system in accordance with an embodiment.

FIG. 6A is a diagrammatic representation of a display with a user interface for enrolling a user in a telepresence system in accordance with an embodiment.

FIG. 6B is a diagrammatic representation of a display with a user interface for managing images of a user in a telepresence system in accordance with an embodiment.

FIG. 7 is a process flow diagram which illustrates a general method of utilizing a face-recognition-based identification system to enroll a user in a telepresence system in accordance with an embodiment.

### DESCRIPTION OF EXAMPLE EMBODIMENTS

### General Overview

According to one aspect, a method includes obtaining a first image of a party that is stored in a first structure in response to an instruction to enroll the user in a system, and using information associated with the first image to identify a second image stored in a second structure. The second image has a relatively high likelihood of depicting the party. Finally, the method includes enrolling the party in the system, wherein enrolling the party in the system includes associating the second image with the party.

### Description

When a party enrolls, or creates a profile, in a telepresence system, the party generally must provide a high-quality image of himself or herself. The image provided by the party is typically a relatively high resolution image that the party must obtain. In general, either the party uploads a high-quality image of himself or herself into the telepresence system during an enrollment process, or the party must position himself or herself in front of a qualifying camera, e.g., a relatively high resolution camera, to take a high-quality snapshot during an enrollment process. Enrollment processes used to enroll a party in a telepresence system are typically time-consuming and inefficient due, at least in part, to the need for the party to provide a high-quality image of himself or herself. A high-quality image is generally preferred over a low-quality image, as a high-quality image enhances performance of the telepresence system.

By providing a user-friendly method of enrolling users in a telepresence system, the efficiency with which an enrollment process may occur is enhanced. In one embodiment, a method of enrolling a user in a telepresence system utilizes a face-recognition-based identification system that obtains information from the user such as a corporate identifier (ID), uses the obtained information to locate a stored image of the user, and effectively compares the stored image to high-quality sample images stored in a repository to obtain a high-quality image of the user to use to enroll the user. A stored image of a user may be a low-quality image stored in a database, e.g., a directory database associated with a corporate enterprise of which the user is a part. Sample images may include images captured during the course of previous telepresence sessions. A face-recognition-based identification system generally obtains an existing, known image of a user using identifying information provided by the user, characterizes the known image, and then searches a set of sample images to identify images that are likely to depict the user, i.e., images that substantially match features or characteristics of the known image. The sample images are typically of a higher resolution than the stored image. That is, sample images may have higher quality biometric signatures than the stored image. As such, relatively high resolution images of a user may be obtained in an efficient manner.

A sample collection process may be performed during telepresence sessions to obtain high-quality images, e.g., images with relatively high quality biometric signatures, that may be used by a face-recognition-based identification system during an enrollment process. During telepresence sessions, sample images may be captured and stored in a telepresence system, e.g., in an un-enrolled sample database, such that the sample images may be accessed during an enrollment process.

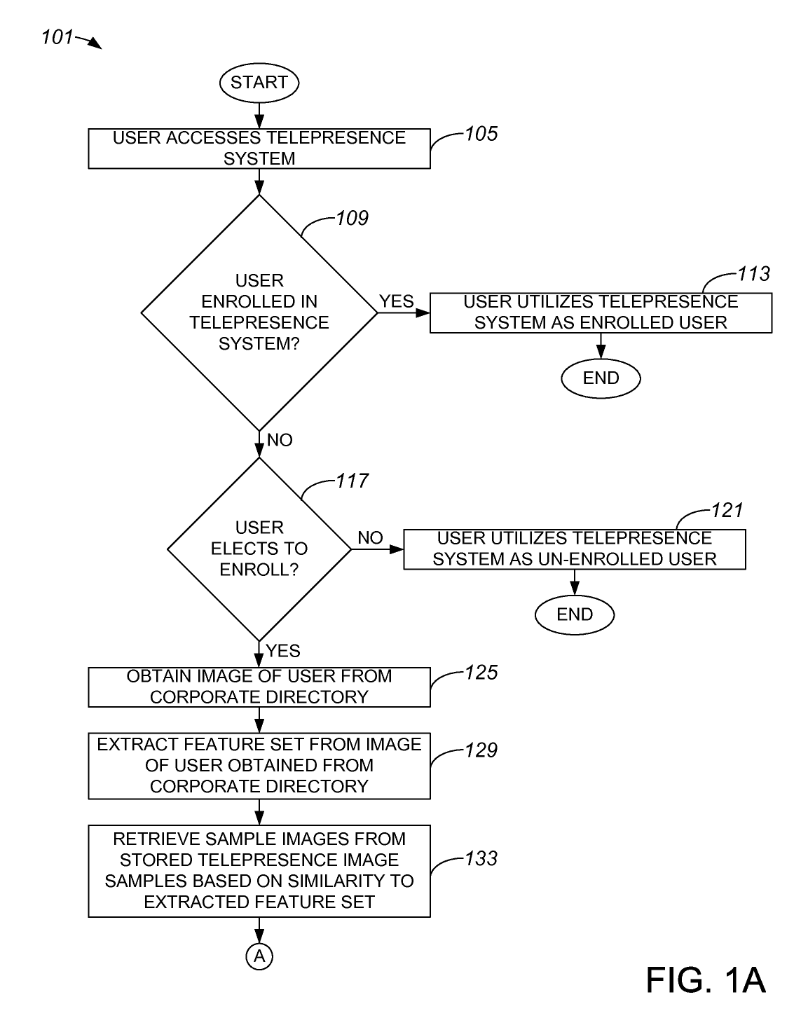

Referring initially to FIGS. 1A and 1B, a method of enrolling a user in a telepresence system using a face-recognition-based identification system will be described in accordance with an embodiment. A method 101 of enrolling a user in a telepresence system begins at step 105 in which a user accesses a telepresence system. It should be appreciated that prior to the user accessing the telepresence system, sample images of the user have already been obtained and stored with respect to a corporate directory. A user may access a telepresence system in order to participate in a telepresence session, or may access a telepresence system to enroll, e.g., to create a user profile and/or an account. Accessing a telepresence system may include, but is not limited to including, using a computing system to interact with a user interface for a telepresence system.

After the user accesses the telepresence system, it is determined in step 109 whether the user is enrolled in the telepresence system. Determining whether the user is enrolled in the telepresence system may include determining whether the user has a user profile and/or an account on the telepresence system. If it is determined that the user is enrolled in the telepresence system, then the user utilizes the telepresence system as an enrolled user in step 113, and the method of enrolling a user terminates.

Alternatively, if it is determined in step 109 that the user is not enrolled in the telepresence system, it is determined in step 117 whether the user elects to enroll in the telepresence system. A user may indicate that he or she elects to enroll in the telepresence system by interacting with a user interface associated with the telepresence system, for example, to substantially specify an intent to enroll. A user may indicate an intent to enroll by accessing an enrollment interface. If the user does not elect to enroll in the telepresence system, then the user utilizes the telepresence system as an un-enrolled user in step 121, and the method of enrolling a user terminates. If, however, the user elects to enroll in the telepresence system in step 117, then process flow proceeds to step 125 in which an image of the user is obtained from a corporate directory, e.g., a database associated with an enterprise, in step 125. As will be appreciated by those skilled in the art, the image of the user stored in a corporate directory is typically a relatively low resolution image. For example, the image of the user stored in a corporate directory is typically a relatively low resolution image, e.g., having between approximately 90 and approximately 120 pixels between eyes, and is of relatively low quality due to substantial compression. In comparison, images obtained in a telepresence system may generally have more than approximately 200 pixels between eyes. The image of the user may be obtained, in one embodiment, when the user inputs or otherwise provides information to the telepresence system that may be used to locate the image. The information inputted or otherwise provided by the user may includes information including, but not limited to including, a name of the user, a username of the user, a user ID or a corporate ID associated with the user, an email address of the user, a login ID of the user, and/or a telephone number of the user.

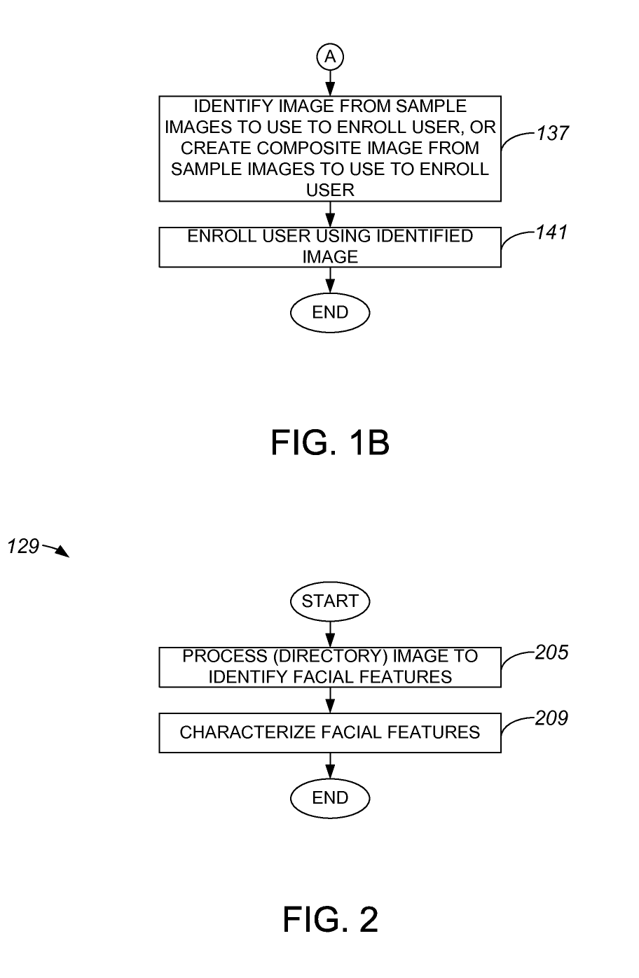

After an image of the user is obtained from a corporate directory, i.e., after the directory image of the user is obtained, a feature set may be extracted from the image in step 129. A feature set may include indicators associated with characteristics such as eye color and hair color, as well as other characteristics that may substantially define facial features or landmarks depicted in the image. Feature sets, which may include a signature generated from the directory image, may generally be extracted using any suitable facial-recognition algorithm. A feature set extraction may include, but is not limited to including, partitioning a facial image into blocks, applying local image transforms to the blocks, selecting amplitudes at certain spatial frequencies in the transforms blocks, combining the results into a vector, and/or compressing results that are combined into a vector. In one embodiment, the feature set may be extracted substantially in real time, e.g., substantially when the directory image is obtained in step 125. It should be appreciated, however, that the feature set may instead be substantially extracted from the image prior to the image being obtained from the corporate directory, as for example when the image is first stored in the corporate directory. One process of extracting a feature set will be discussed below with reference to FIG. 2.

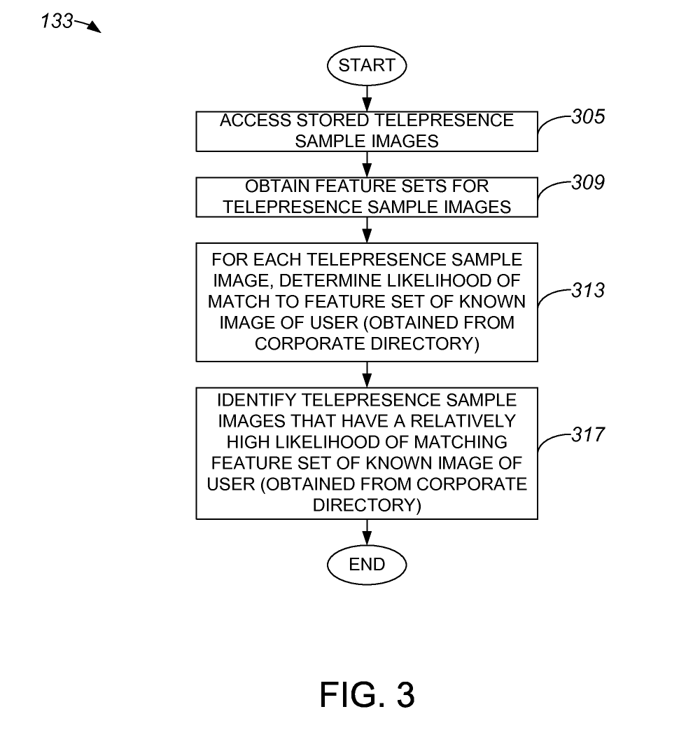

Once the feature set is extracted from the directory image of the user, sample images are retrieved or otherwise obtained from stored telepresence image samples in step 133. The sample images are retrieved based on similarities to the feature set extracted from the directory image of the user. In general, the sample images that most closely match the feature set and are, therefore, have a high likelihood of being images of the user, are retrieved. Substantially any suitable algorithm may be used to process sample images to identify images that have a relatively high likelihood of being images of the user, i.e., of having a relatively high likelihood of depicting the user. One process of retrieving sample images based on similarity to the feature set extracted from the directory image of the user will be described below with respect to FIG. 3.

Generally, telepresence image samples may be stored in a database associated with the telepresence system, and may be obtained during previous telepresence sessions. That is, images of participants in telepresence sessions may be taken and stored in a database. The stored images are generally relatively high resolution images. In one embodiment, feature sets may be identified and stored with the images.

From step 133, process flow moves to step 137 in which an image is effectively identified for use to enroll the user. The image used to enroll the user may generally be identified in any suitable manner. For example, the telepresence system may select the sample image with a feature set that is a substantially best match to the feature set of the directory image of the user, or the user may select a sample image from a set of sample images. In one embodiment, the telepresence system may essentially create a composite image of the user from the sample images retrieved in step 133. Such a composite image may represent a signature, or a high-quality biometric template, of the face of the user. After an image is identified for use to enroll the user, the user is enrolled in step 144 using the identified image, and the method of enrolling a user in a telepresence system is completed.

FIG. 2 is a process flow diagram which illustrates a process of extracting a feature set from an image of a user, e.g., step 129 of FIG. 1A, in accordance with an embodiment. A process 129 of extracting a feature set from an image of a user, e.g., a directory image of a user, begins at step 205 in which the image of the user is processed such that facial features may be identified. Any suitable face recognition algorithm may be used to identify features in the image of the user. The identified features are characterized in step 209. Characterizing the features may include assigning values to each feature. Once features are characterized, the process of extracting a feature set from the image of the user is completed.

With reference to FIG. 3, a process of retrieving sample images based on a feature set, e.g., step 133 of FIG. 1A, will be described in accordance with an embodiment. A process 133 of retrieving sample images begins at step 305 in which stored telepresence sample images are accessed. As previously mentioned, sample images may be captured during telepresence sessions and stored in a repository or database associated with a telepresence system. Once the sample images are accessed, feature sets for the sample images are obtained in step 309. The feature sets associated with the sample images may be obtained substantially in real-time using a face recognition algorithm, as for example when the sample images are accessed. Alternatively, feature sets may be obtained when sample images are capture, and may be stored with the sample images.

For each sample image, a likelihood that the sample image matches a known image of a user, e.g., a directory image of the user, is determined in step 313. In general, the feature sets of each sample image may be compared with the feature set of the known image of the user to essentially assess the similarities between each sample image and the known image of the user. Any suitable face recognition algorithm may be used to compare the sample images to the known image of the user.

Sample images that have a relatively high likelihood of matching the known image of the user are identified in step 317. That is, sample images which have a relatively high probability of depicting the user are identified. In one embodiment, a threshold may be set such that sample images with a likelihood of matching the known image of the user that is above the threshold may be identified as having a relatively high likelihood of matching the known image of the user. The process of retrieving sample images is completed after sample images that have a relatively high likelihood of matching the known image of the user are identified.

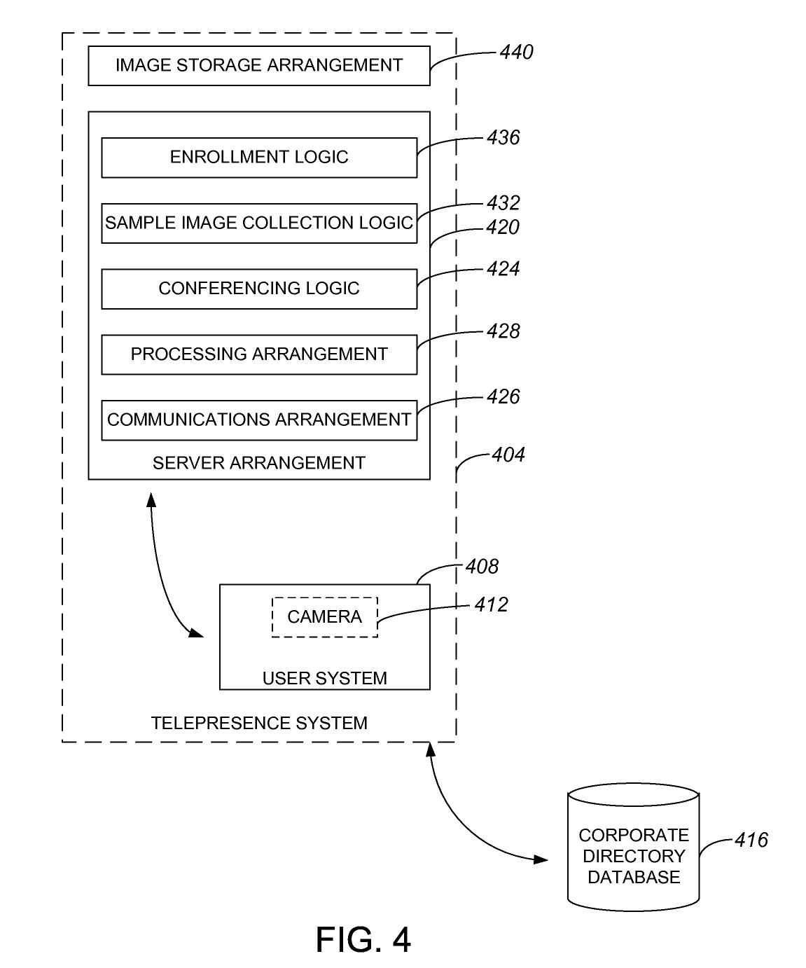

FIG. 4 is a block diagram representation of a telepresence system in accordance with an embodiment. A telepresence system 404 includes a user system 408, a server arrangement 420, and an image storage arrangement 440. A user system 408 may be a computing system that is used by a user to interact with server arrangement 420. In general, user system 408 includes a camera 412, e.g., a high resolution camera, that may be used to capture images during a telepresence session.

Server arrangement 420 includes conferencing logic 424 that is arranged to support telepresence sessions and a communications arrangement 426 that allows server arrangement 420 to communicate with user system 408 as well as external sources, e.g., a corporate directory database 416. Communications arrangement 426 may include input and output interfaces that support communications over a network. Server arrangement 420 also includes a processing arrangement 428 configured to execute logic associated with server arrangement 420.

Sample image collection logic 432, which is included in server arrangement 420, is arranged to cooperate with camera 412 to capture images of parties while the parties are participating in telepresence sessions. That is, sample image collection logic 432 captures images during the course of telepresence sessions. In addition to capturing sample images, image collection logic 432 stores the sample images in image storage arrangement 440. Sample images may be stored in an un-enrolled sample portion (not shown) of image storage arrangement 440.

Enrollment logic 436 includes a user interface arrangement that allows a user to enroll in telepresence system 404. Through the user interface arrangement, a user may provide identifying information that enrollment logic may use to access corporate directory database 416 to obtain a known image, e.g., a relatively low resolution image, of the user. A face recognition engine that is a part of enrollment logic 436 may essentially characterize the known image of the user, and use the characterization of the known image to substantially search for sample images in image storage arrangement 440 that are likely to be images of the user. Enrollment logic 436 is generally configured either to unroll the user in telepresence system using one of the sample images, or to enroll the user in telepresence system 404 using a biometric template or signature of the face of the user created from the sample images.

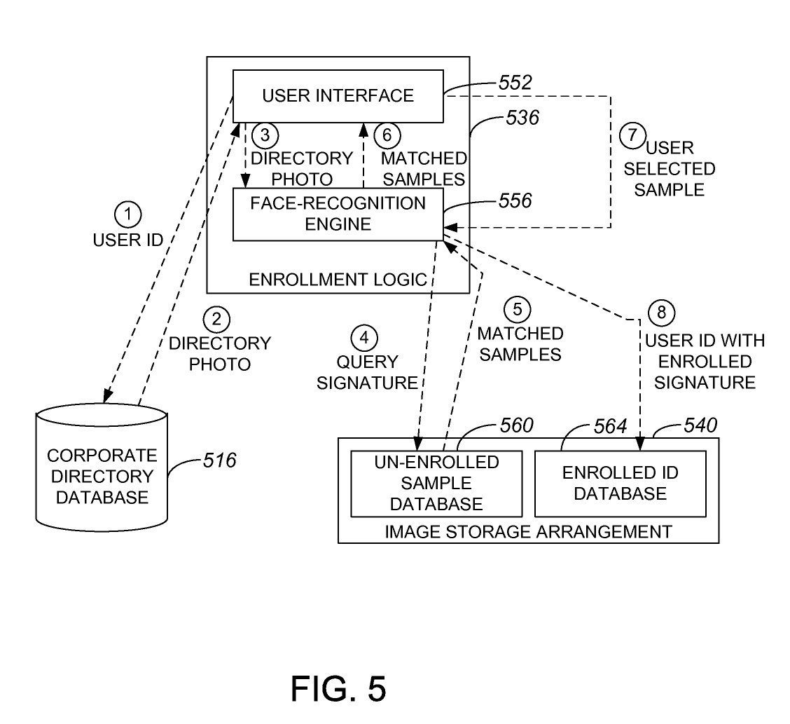

FIG. 5 is a diagrammatic representation of a method of enrolling a user in a telepresence system in accordance with an embodiment. A telepresence system generally includes enrollment logic 536 and an image storage arrangement 540, e.g., a database. Enrollment logic 536 includes a face-recognition engine 556, e.g., a face-recognition-based identification system, and a user interface 552 that a user may use to participate in an enrollment process. Image storage arrangement 540 includes an un-enrolled sample database 560 that stores sample images captured during telepresence sessions, e.g., previously completed telepresence sessions, and an enrolled ID database 564 that contains images and information associated with enrolled users.

In the described embodiment, when a user accesses user interface 552 to enroll in a telepresence system, the user provides information such as a user ID. Enrollment logic 536 uses the user ID provided by the user to index into a corporate directory database 516, which may be external to a telepresence system, to locate an image of the user. The image of the user stored in corporate directory database 516 may generally be a relatively low resolution directory photo.

Once the directory photo of the user is obtained, the directory photo is provided to face-recognition engine 556 such that a feature set or a signature of the directory photo may be identified. That is, face-recognition engine 556 effectively characterizes the directory photo. After the directory photo is effectively characterized, a query signature may be generated. The query signature is provided by race-recognition engine 556 to un-enrolled sample database 560, and is arranged to identify sample images stored in un-enrolled sample database 560 that have a relatively high likelihood of depicting the user. In other words, using the query signature, relatively high resolution sample images which may substantially match the directory photo may be located in un-enrolled sample database 560.

Sample images that substantially match the directory photo and are, therefore, likely to be images of the user are provided to face-recognition engine 556. In one embodiment, the sample images are presented to the user using user interface 552 such that the user may select an image to use to complete his or her enrollment in the telepresence system. It should be appreciated, however, that in lieu of allowing the user to select an image, face-recognition engine 556 may select an image or may create a composite image from the sample images that substantially match the directory photo.

After a sample image is selected, the user ID and the selected sample image are associated with each other, and are provided to enrolled ID database 564. Once enrolled ID database 564 is provided with the user ID and the selected sample image of a user, the user is successfully enrolled in the telepresence system.

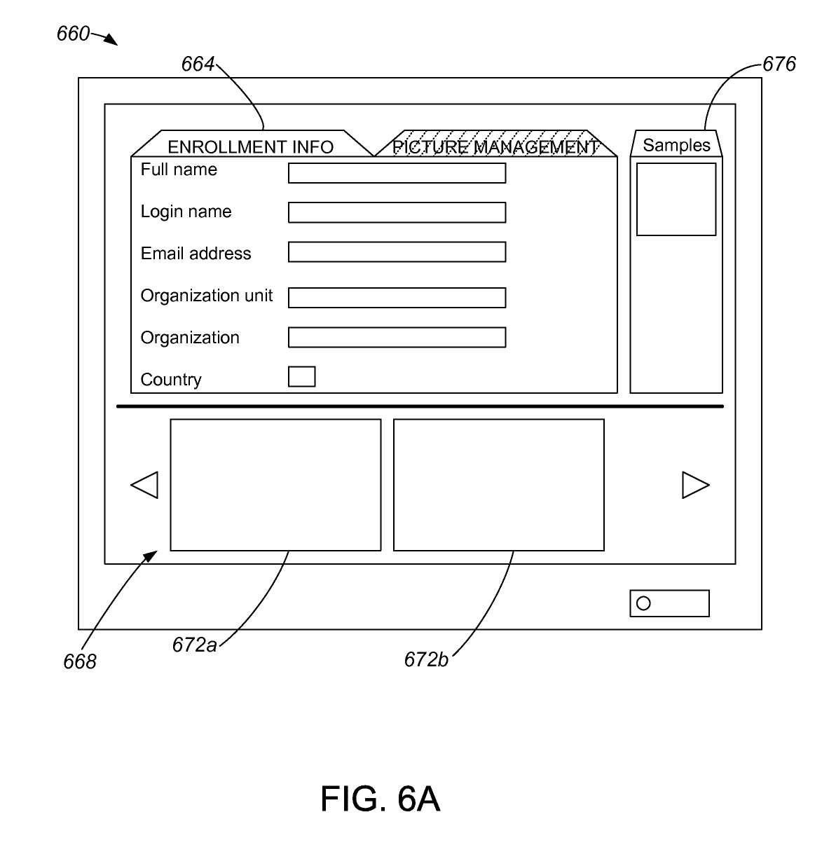

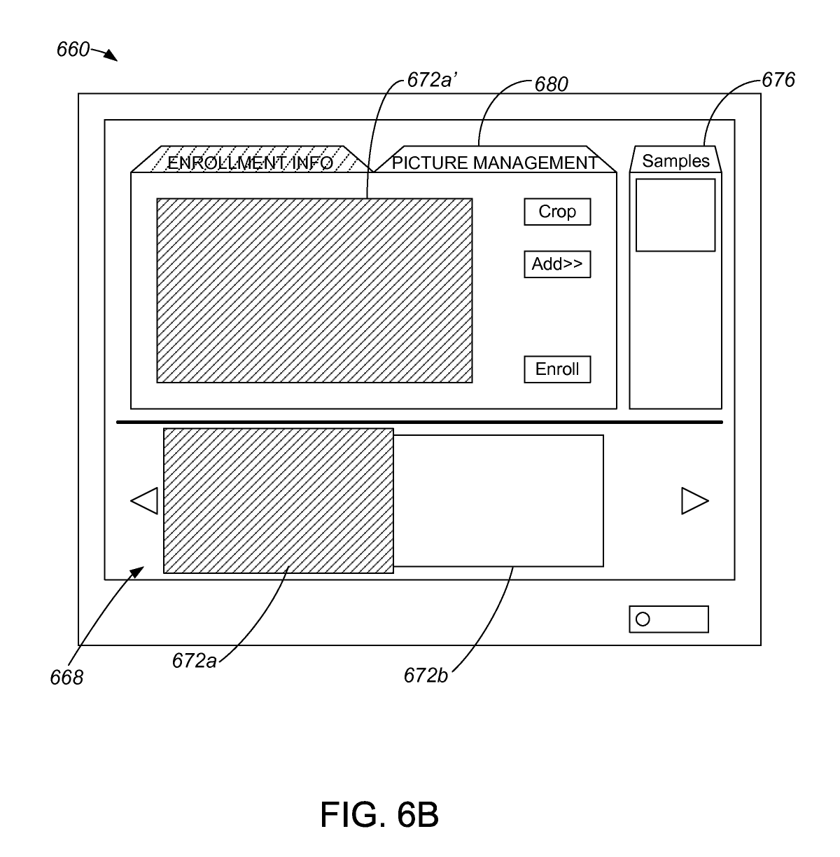

A user interface, e.g., user interface 552 of FIG. 5, generally allows a user to provide information that is used to enroll the user in a telepresence system. Such a user interface may be presented on a display screen associated with a telepresence system, and may be a graphical user interface. It should be appreciated that a user interface may be a web page that a user may access from a computer via a network. FIG. 6A is a diagrammatic representation of a display with a user interface for enrolling a user in a telepresence system in accordance with an embodiment. A display 660 presents an enrollment screen 664 in which a user may provide information including his or her name, login ID, and/or email address. Display 660 also presents a section 676 in which a known image of the user may be shown The known image of the user may be an image of the user obtained, for example, from a directory database using information entered in enrollment screen 664. Once obtained, sample high-quality images 672a, 672b, such as those obtained from an un-enrolled sample database such as un-enrolled sample database 560 of FIG. 5, may be presented to the user in a section 668. In one embodiment, substantially all images obtained from an un-enrolled sample database that have a relatively high likelihood of depicting the user may be displayed in section 668. It should be appreciated, however, that the number of images displayed in section 668 may instead be limited.

A user may select an image 672a, 672b to use to complete his or her enrollment in a telepresence session. Once the user selects an image 672a, 672b, the user may edit the selected image 672a, 672b. That is, the user may generally manage a selected image 672a, 672b. FIG. 6B is a diagrammatic representation of a display, e.g., display 660 of FIG. 6A, with a user interface for managing images of a user in a telepresence system in accordance with an embodiment. As shown, a user has selected image 672a to use to complete an enrollment process. When image 672a is selected, a representation 672a′ of image 672a is shown in a picture management 680 screen. While picture management screen 680 is displayed, a user may effectively edit representation 672a′. For example, a user may crop representation 672′. When the user has finished editing representation 672a′, the user may complete the enrollment process.

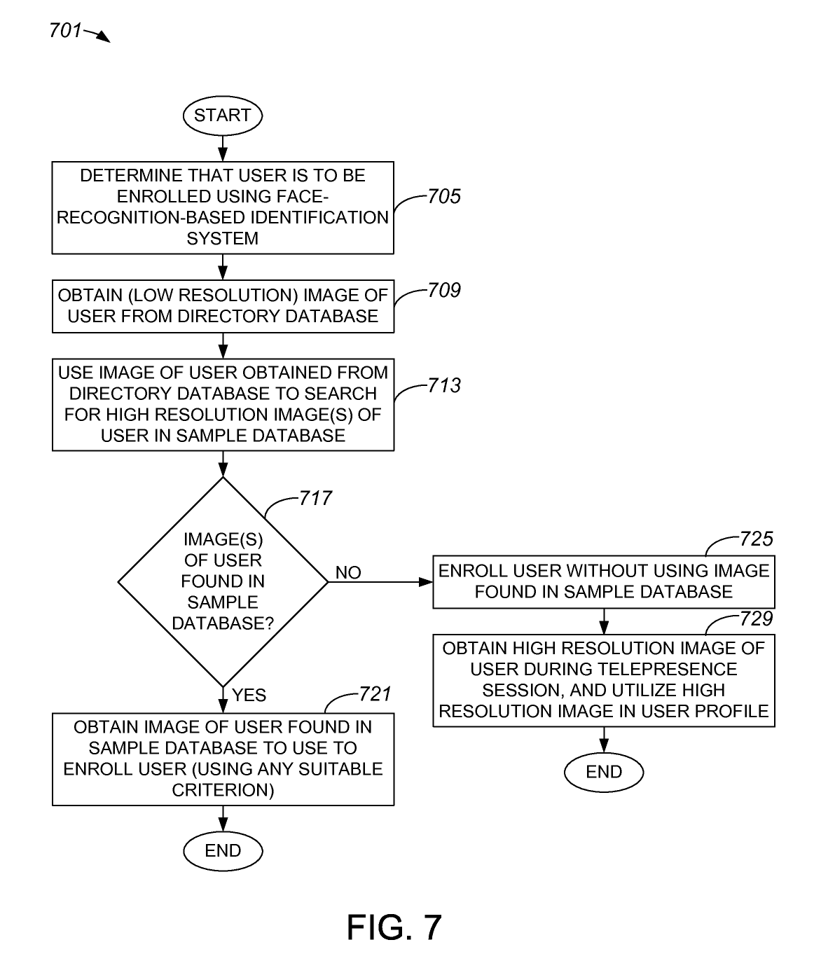

In general, a face-recognition-based identification system may be utilized to identify a relatively high resolution image that may be used by a user to enroll in a telepresence system when the user accesses the telepresence system to participate in a conference. That is, a user may enroll in a telepresence system when the user accesses the telepresence system to take part in a conference. FIG. 7 is a process flow diagram which illustrates a general method of utilizing a face-recognition-based identification system to enroll a user in a telepresence system in accordance with an embodiment. A method 701 of utilizing a face-recognition-based identification system associated with a telepresence system begins at step 705 in which the telepresence system determines that a user is to be enrolled in the telepresence system using the face-recognition-based identification system. It may be determined that the user is to be enrolled, in one embodiment, when the user accesses the telepresence system to join a conference call and the user is identified as not already enrolled. In other words, when an un-enrolled user accesses a telepresence system to join a telepresence session or a conference call, it may be determined that the user is to be enrolled. In one embodiment, a user may actively pursue enrollment by accessing a web-based interface on a computer and via a network.

In step 709, an image of the user may be obtained from a directory database. The image is typically a relatively low resolution image, such as an image that is displayed on an ID tag of the user or displayed in a directory profile of the user. The image of the user may be obtained, as previously discussed, using information provided by the user such as a name, an e-mail address, a user ID, and/or a login ID. After a relatively low resolution image of the user is obtained form a directory database, the relatively low resolution image is used to search for at least one relatively high resolution image of the user in step 713. The relatively low resolution image or, in one embodiment, a feature set extracted from the relatively low resolution image, is used by the face-recognition-based identification system to search a sample database for relatively high resolution images that are likely to substantially match the relatively low resolution image. The sample database generally contains images captured by the telepresence system during conference calls.

A determination is made in step 717 as to whether any relatively high resolution images of the user were found in the sample database. If the determination in step 717 is that at least one relatively high resolution image of the user has been identified in the sample database, a relatively high resolution image of the user is obtained in step 721 from the sample database, and is used to enroll the user. In general, any suitable criterion may be used to obtain the relatively high resolution image. For example, a user may select the relatively high resolution image based on his or her preferences, or the relatively high resolution image may effectively be selected by the face-recognition-based identification system as being the image that best matches the relatively low resolution image and/or a feature set substantially extracted from the relatively low resolution image. In one embodiment, the relatively high resolution image used to enroll the user may be a composite of one or more images obtained from the sample database. Once the relatively high resolution image of the user is obtained and used to enroll the user, the method of utilizing a face-recognition-based identification system associated with a telepresence system is completed.

Alternatively, if it is determined in step 717 that no relatively high resolution images of the user are found in the sample database, the indication is that either no images of the user are in the sample database, or any images of the user in the sample database are not identifiable. Accordingly, in the described embodiment, the user is enrolled without using an image found in the sample database in step 725. By way of example, the user may be allowed to complete the enrollment process and create a user profile without a relatively high resolution image. Upon enrolling the user without an image, the user may be allowed to participate in a telepresence session. During the telepresence session, at least one relatively high resolution image of the user may be obtained in step 729, and a relatively high resolution image of the user obtained during the telepresence session may be used to complete the user profile. After the relatively high resolution image is used to substantially complete the user profile, the method of utilizing a face-recognition-based identification system associated with a telepresence system is completed.

Although only a few embodiments have been described in this disclosure, it should be understood that the disclosure may be embodied in many other specific forms without departing from the spirit or the scope of the present disclosure. By way of example, while a face-recognition-based identification system has been described as being suitable for use in enrolling a user with respect to a telepresence system, a face-recognition-based-identification system is not limited to being used to enroll a user with respect to a telepresence system. A face-recognition-based identification system that uses information associated with a party to obtain a relatively low resolution image of the party, and then effectively uses the relatively low resolution image of the party to search a database to find a relatively high resolution image of the party, may be used with respect to any system that may benefit from enrolling the party using a relatively high resolution image of the party.

In one embodiment, a face-recognition-based identification system may be used in social networking, for example, where a relatively low resolution, low quality image of a party may be obtained using a camera of a mobile phone and obtained under an uncontrolled illumination environment. Such an image may then be used to search a database that contains relatively high resolution, high quality photos of the party, possibly with other parties, and enroll the party an identification system with the relatively high resolution, high quality images.

More than one relatively low resolution image of a party may be obtained and used to extract a feature set associated with the party. Further, more than one relatively high resolution image of the party may be obtained using multiple relatively low resolution images. It should be appreciated that any number of relatively high resolution images may be used to create a biometric signature associated with the party.

In general, once an enrollment process is initiated, a relatively low resolution image of a party is obtained and essentially utilized to locate a relatively high resolution image of the party that may be used to substantially complete the enrollment process. It should be appreciated that a relatively high resolution image may generally be any image that has a higher resolution that the relatively low resolution image.

Once a party is enrolled in a telepresence system, and a relatively high resolution image of the party is effectively associated with the party, the party may be substantially tracked while participating in a telepresence session. The image associated with the party may be used to detect and to track the presence of the party during a telepresence session. Hence, when the presence of the party is no longer detected in the telepresence session, the party may be identified as having left the telepresence session. Similarly, when a party that is enrolled in a telepresence system is detected in a telepresence session, the party may be identified as having joined the telepresence session.

Substantially any suitable interface may be used to enroll a party with respect to a telepresence system. Suitable enrollment interfaces may include, but are not limited to including, an online interface associated with a telepresence system or an offline interface associated with a telepresence system.

The embodiments may be implemented as hardware and/or software logic embodied in a tangible medium that, when executed, is operable to perform the various methods and processes described above. That is, the logic may be embodied as physical arrangements or components. A tangible medium may be substantially any computer-readable medium that is capable of storing logic which may be executed, e.g., by a computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining a first image of a party, the first image being stored in a first structure, wherein the first image is obtained in response to an instruction to enroll the user in a system;
using information associated with the first image to identify a second image, the second image being stored in a second structure, the second image having a relatively high likelihood of depicting the party; and
enrolling the party in the system, wherein enrolling the party in the system includes associating the second image with the party.

2. The method of claim 1 further including:
obtaining a feature set associated with the first image, wherein using the information associated with the first image to identify the second image includes identifying a feature set associated with the second image and determining that the feature set associated with the first image substantially matches the feature set associated with the second image.

3. The method of claim 2 wherein using the information associated with the first image to identify the second image includes identifying a plurality of images, the plurality of images including the second image, wherein each of the plurality of images has an associated feature set that substantially matches the feature set associated with the first image.

4. The method of claim 3 wherein using the information associated with the first image to identify the second image from the plurality of images includes presenting the plurality of images to the party, and wherein the party identifies the second image by selecting the second image.

5. The method of claim 1 wherein the first image is a relatively low resolution image and the second image is a relatively high resolution image.

6. The method of claim 5 wherein the system is a telepresence system, and wherein the first structure is a directory database and the second structure is a database associated with the telepresence system.

7. The method of claim 6 wherein the second image is an image obtained by the telepresence system during a telepresence session.

8. The method of claim 1 wherein enrolling the party in the system further including creating a composite image of the party using at least the second image and enrolling the party using the composite image.

9. The method of claim 1 wherein enrolling the party in the system includes enrolling the party using the second image.

10. The method of claim 1 wherein associating the second image with the party includes creating a biometric signature using at least the second image and associating the biometric signature with the party.

11. An apparatus, the apparatus being a part of a telepresence system, the apparatus comprising:
means for obtaining a first image of a party, the first image being stored in a directory database and having a first resolution, wherein the first image is obtained in response to an instruction to enroll the user in the telepresence system;
using information associated with the first image to identify a second image, the second image being stored in a database associated with the telepresence system, the second image having a relatively high likelihood of depicting the party, the second image having a second resolution, the second resolution being a higher resolution that the first resolution; and
enrolling the party in the telepresence system, wherein enrolling the party in the system includes associating the second image with the party.

12. A tangible, non-transitory computer-readable medium comprising computer program code, the computer program code, when executed, configured to:
obtain a first image of a party, the first image being stored in a first structure, wherein the first image is obtained in response to an instruction to enroll the user in a system;
use information associated with the first image to identify a second image, the second image being stored in a second structure, the second image having a relatively high likelihood of depicting the party; and
enroll the party in the system, wherein enrolling the party in the system includes associating the second image with the party.

13. The tangible, non-transitory computer-readable medium of claim 12 wherein the computer program code is further configured to:
obtain a feature set associated with the first image, wherein the computer program code configured to use the information associated with the first image to identify the second image is further configured to identify a feature set associated with the second image and to determine that the feature set associated with the first image substantially matches the feature set associated with the second image.

14. The tangible, non-transitory computer-readable medium of claim 13 wherein the computer code configured to use the information associated with the first image to identify the second image is further configured to identify a plurality of images, the plurality of images including the second image, wherein each of the plurality of images has an associated feature set that substantially matches the feature set associated with the first image.

15. The tangible, non-transitory computer-readable medium of claim 14 wherein the computer code configured to use the information associated with the first image to identify the second image from the plurality of images is further configured to present the plurality of images to the party, and wherein the computer code is further configured to enable the party to identify the second image by selecting the second image.

16. The tangible, non-transitory computer-readable medium of claim 12 wherein the first image is a relatively low resolution image and the second image is a relatively high resolution image.

17. The tangible, non-transitory computer-readable medium of claim 16 wherein the system is a telepresence system, and wherein the first structure is a directory database and the second structure is a database associated with the telepresence system.

18. The tangible, non-transitory computer-readable medium of claim 17 wherein the second image is an image obtained by the telepresence system during a telepresence session.

19. The tangible, non-transitory computer-readable medium of claim 12 wherein the computer code configured to enroll the party in the system is further configured to create a composite image of the party using at least the second image and enrolling the party using the composite image.

20. The tangible, non-transitory computer-readable medium of claim 12 wherein the computer code configured to enroll the party in the system is further configured to enroll the party using the second image.

21. The tangible, non-transitory computer-readable medium of claim 12 wherein associating the second image with the party includes creating a biometric signature using at least the second image and associating the biometric signature with the party.

22. An apparatus comprising:
a storage arrangement, the storage arrangement arranged to store a plurality of sample images, the plurality of sample images each having a first resolution; and
a server arrangement, the server arrangement including enrollment logic configured to obtain information associated with a party and to use the information to obtain an image of the party, the image of the party having a second resolution that is lower than the first resolution, wherein the enrollment logic is further configured to use the image of the party to identify at least a first sample image of the plurality of samples stored in the storage arrangement that depicts the party and to associate the first sample image with the party during an enrollment process.

23. The apparatus of claim 22 wherein the enrollment logic is still further configured to enroll the party using the first sample image during the enrollment process.

24. The apparatus of claim 22 wherein the enrollment logic is still further configured to use at least the first sample image to create a composite image of the party, and wherein the enrollment logic enrolls the party using the composite image during the enrollment process.

25. The apparatus of claim 22 wherein the server arrangement further includes a communications arrangement, and wherein the enrollment logic cooperates with the communications arrangement to access an external database to obtain the image of the party.

26. The apparatus of claim 22 wherein the apparatus is associated with a telepresence system, and wherein server arrangement further includes conferencing logic configured to support telepresence sessions.

27. The apparatus of claim 26 wherein the enrollment process is arranged to enroll the party with respect to the telepresence system.

28. The apparatus of claim 26 wherein the plurality of sample images are obtained during telepresence sessions.

29. The apparatus of claim 22 wherein the information associated with the party is one selected from a group including a name, an email address, a login identifier, and a user identifier.

30. The apparatus of claim 22 wherein the enrollment logic is configured to use the image of the party to identify the first sample image by obtaining a feature set associated with the image of the party and determining that the first sample image includes features that have a relatively high likelihood of matching the feature set.
